(19) United States
(12) Patent Application Publication
(10) Pub. No.: US 2011/0220705 A1
(43) Pub. Date: Sep. 15, 2011

(54) GLOVE BOX ORGANIZER

(76) Inventors: Isabel Acevedo, Bristol, CT (US); Alex Jarrin, Bristol, CT (US); Patricia Acevedo, Bristol, CT (US)

(21) Appl. No.: 13/042,673

(22) Filed: Mar. 8, 2011

Related U.S. Application Data
(60) Provisional application No. 61/313,427, filed on Mar. 12, 2010.

(51) Int. Cl. B42F 7/08

(52) U.S. Cl. 229/67.3

(57) ABSTRACT

A glove box organizer for storing contents of a glove box of a motor vehicle. The glove box organizer is an accordion file folder having folder sections. The folder sections include an assortment of pockets, holders and dividers for separately storing contents in the glove box. The folder sections have tabs mounted thereto for identifying the contents of one or more of the folder sections. The glove box organizer includes a rigid support for propping open and clamping shut the glove box organizer at a given width. A bottom panel of the glove box organizer defines a recess for receiving a locking mechanism of the glove box. A flexible membrane is mounted to the bottom panel and substantially occupies the recess to seal the bottom panel while enabling the recess to receive the locking mechanism of the glove box.

### PRIORITY CLAIM OR CROSS-REFERENCE TO RELATED CASE

The present application claims the benefit of provisional U.S. Patent Application Ser. No. 61/313,427 filed on Mar. 12, 2010, which is hereby incorporated by reference.

### FIELD OF THE INVENTION

The invention relates to an organizing system for a storage compartment of a vehicle and, more specifically, to an accordion file folder organizing system for a glove box of a motor vehicle.

### BACKGROUND OF THE INVENTION

Initially, vehicles were outfitted with glove boxes to store a few important driving accessories. However, as people spent more time in their cars, trucks and other vehicles, the need to have more items on their person in the vehicle has increased. For instance, the original glove box was small and stored only a select few items including gloves, goggles and the like. In comparison, today, the number of items stored in the glove box has drastically increased to include vehicle registration information, vehicle operating manuals, navigational aids (e.g., maps, global positioning system devices, travel guides, etc.), entertainment products (e.g., compact discs, digital video discs, mp3 players, etc.) and any manner of other products (e.g., road flares, sun screen, sun glasses, snack food, etc.).

Referring to FIG. 1, an example of a modern glove box 10 is shown in an open position. The glove box 10 is pivotally mounted to an underside of a dashboard 12 of the vehicle and retained by a pneumatic piston 14. The glove box 10 is substantially box-shaped and has a bottom wall 16, a rear wall 18, two side walls 20, 20 and a top wall 22. The bottom wall 16 of the glove box 10 includes a locking mechanism 24 that engages a clasp 26 mounted to the dashboard 12.

In spite of improvements to the size of the glove box 10, little or nothing has been done to address the organization or efficiency of the use of the glove box 10, overall. Referring to FIG. 2, the glove box 10 is shown with an example of typical contents inserted therein. As shown in FIG. 2, the contents of the glove box 10 are loosely assembled without any organization. The contents are free to move around in the glove box 10 during operation and, when the glove box 10 is moved between the open and closed positions, and when a user handles the contents to find a particular content item. As a result of the loose arrangement, the contents are prone to damage and tampering.

When using the known glove box 10, it can be difficult to access contents stored in the glove box 10 and return the contents to their previous position, particularly while minimizing damage to the contents from handling. Further, it could take a significant amount of time to identify the particular item that is desired. This is exacerbated, for instance, following an accident or a police stop when injury or stress can fluster the driver and the passengers. During such moments, the driver may have difficulty finding particular items and, thus, believe that the particular item that is desired is missing or lost. However, the particular item that is desired may be in the glove box 10 and is merely concealed or intermingled with other items.

During cleaning or when the user acquires a new vehicle, it may be desirable or necessary to remove all of the contents from a glove box of a first vehicle. In such instances, the user might want to retain the contents of the glove box in a relatively fixed arrangement (i.e., keep a stack of documents in the same order) while avoiding significant tampering or handling, and then position the contents back in the glove box of the first vehicle or into a second glove box of a second vehicle. There are no known devices that facilitate the removal of substantially all of the contents of the first glove box. Moreover, there are no known devices that facilitate the migration of substantially all of the contents of the first glove box to the second glove box.

The object of the present invention is, therefore, to provide an improved system for organizing contents of a glove box, which, among other desirable attributes, significantly reduces or overcomes the above-mentioned deficiencies of glove boxes.

### SUMMARY OF THE INVENTION

According to one embodiment, the present invention provides a glove box organizer that includes: an accordion file folder having a bottom panel, a rear panel abutting the bottom panel, a top panel abutting the rear panel and side panels abutting the bottom panel, the rear panel and the top panel; at least one folder-divider positioned between the bottom panel and the top panel, the at least one folder-divider defining, at least in part, two folder sections; and a rigid support mounted to the file folder, positioned to abut the side panels and configured to adjustably retain the bottom panel and the top panel at a fixed distance from one another thereby controlling the size of the at least two folder sections.

According to another embodiment, the present invention provides a glove box organizer that includes: an accordion file folder having a bottom panel, a rear panel abutting the bottom panel, a top panel abutting the rear panel and side panels abutting the bottom panel, the rear panel and the top panel, wherein: the bottom panel, the top panel and the side panels define a front opening that is remote from the rear panel; the bottom panel has an edge that abuts the front opening; the bottom panel defines a recess along the edge of the bottom panel; and the recess is configured to receive a locking mechanism of a glove box of a motor vehicle; at least one folder-divider positioned between the bottom panel and the top panel, wherein: the at least one folder-divider defines at least two folder sections; each folder section defines a slot in the front opening; and a flexible membrane mounted to the bottom panel and positioned to substantially occupy the recess.

According to another embodiment, the present invention provides a glove box organizer for organizing contents of a glove box of a motor vehicle. The glove box organizer consists of: an accordion file folder having a bottom panel, a rear panel abutting the bottom panel, a top panel abutting the rear panel and side panels abutting the bottom panel, the rear panel and the top panel, wherein: the bottom panel, the top panel and the sides define an front opening that is remote from the rear panel; the bottom panel has an edge that abuts the front opening; the bottom panel defines a recess along the edge of the bottom panel that abuts the front opening; and the recess is configured to receive a locking mechanism of a glove box of a motor vehicle; at least one folder-divider positioned between the bottom panel and the top panel; wherein: the at least one folder-divider defines at least two folder sections; at least one elastically deformable pocket mounted in one of the folder sections; at least one holder mounted in one of the folder sections; a rigid support mounted to the file folder, positioned to abut the sides and configured to adjustably retain the bottom panel and the top panel at a fixed distance from one another thereby controlling the size of the at least two folder sections; and at least one tab mounted to one of the folder-dividers, positioned to abut or extend past the front opening and configured to display a label.

It is an object of the present invention to provide a glove box organizer that enables the organization of the contents of the glove box. It is a further object of the present invention to provide a glove box organizer that protects the contents of the glove box from damage and harm.

It is an object of the present invention to provide a glove box organizer that maintains the contents of the glove box in a relatively fixed position during use and handling, when the glove box is moved between the open and closed positions and when the contents are removed the glove box and/or migrated to another glove box.

It is an object of the present invention to provide a glove box organizer that enables the identification, access and return of contents from and to the glove box in a prompt, easy and stress-reducing manner.

In one aspect of the present invention, the glove box organizer includes a rigid support which is capable of clamping shut the glove box organizer, which retains contents stored therein when the glove box organizer is moved or handled.

In another aspect of the present invention the bottom panel is coated with or formed from a material configured to engage a lower wall of a glove box of a motor vehicle.

These and other features of the present invention are described with reference to the drawings of preferred embodiments of a glove box organizer. The illustrated embodiments of the glove box organizer of the present invention are intended to illustrate, but not limit, the invention.

### BRIEF DESCRIPTION OF THE DRAWINGS

FIG. 1 illustrates a glove box of a motor vehicle as known in the art.

FIG. 2 illustrates the glove box of the motor vehicle of FIG. 1 having typical contents inserted therein.

FIG. 3 illustrates a glove box organizer according to one embodiment of the present invention.

FIG. 4 illustrates a glove box organizer according to the embodiment of FIG. 3, with contents stored therein.

FIG. 5 illustrates the glove box organizer according to the embodiment of FIG. 3 with contents stored therein and installed in a glove box of a vehicle.

FIG. 6 illustrates the glove box organizer according to the embodiment of FIG. 3 with contents stored therein and installed in a different glove box of a different vehicle.

FIG. 7 illustrates a glove box organizer according to another embodiment of the present invention.

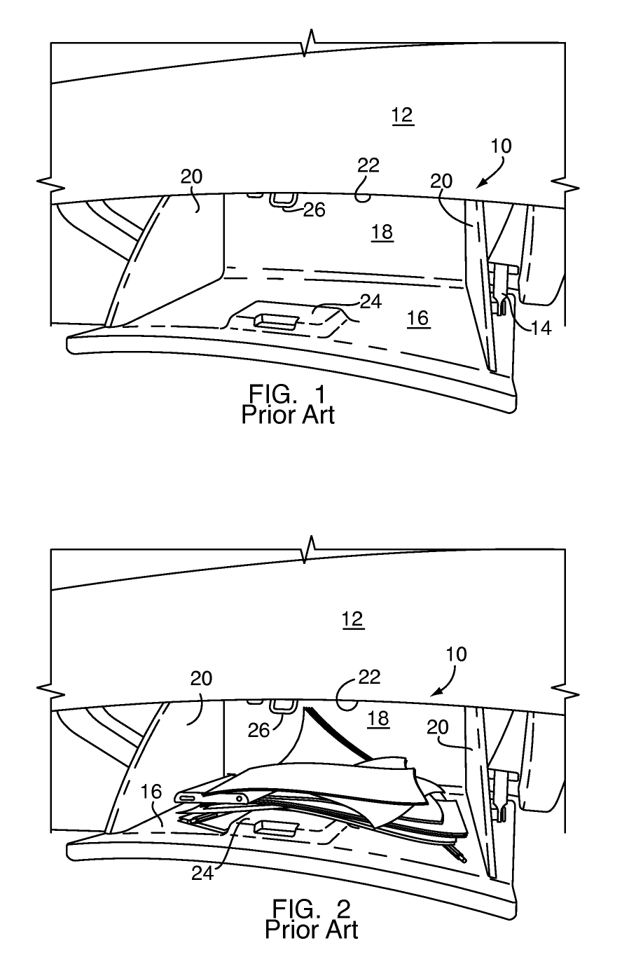

### DETAILED DESCRIPTION OF PREFERRED EMBODIMENTS OF THE PRESENT INVENTION

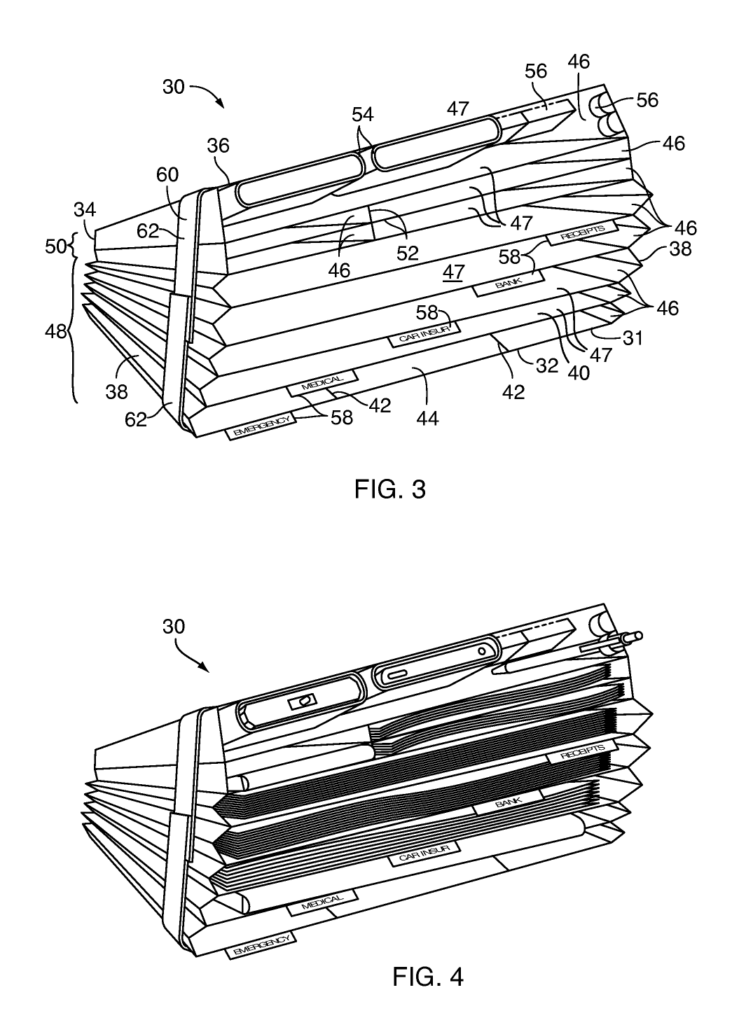

Referring to FIG. 3, a glove box organizer 30 according to one preferred embodiment of the present invention is shown. The glove box organizer 30 is a substantially box-shaped accordion file folder 31 that is configured to be inserted into a glove box of a motor vehicle. The sheets of the accordion file folder 31 are made of a resilient and sturdy material, such as a textile, a leather, a plastic or a metal.

The glove box organizer 30 has a bottom panel 32, a rear panel 34 abutting the bottom panel 32, a top panel 36 abutting the rear panel 34, and two side panels 38, 38 abutting the bottom panel 32, the rear panel 34 and the top panel 36. The bottom panel 32, the top panel 36 and the side panels 38, 38 define a front opening 40 on a distal end of the glove box organizer 30 from the rear panel 34 (i.e., the front opening 40 is remote from the rear panel 34).

The bottom panel 32 of the glove box organizer 30 has a recess 42 defined therein that is configured to receive a locking mechanism of the glove box of the motor vehicle. The recess 42 enables the glove box organizer 30 to be used in any glove box. In other words, the recess 42 promotes the interoperability of the glove box organizer 30 in any glove box. The recess 42 promotes lateral stability of the glove box organizer 30 in the glove box by engaging the locking mechanism with inner side-edges of the bottom panel 32 that define the recess 42. The recess 42 also enables the glove box organizer 30 to more effectively use the space of the glove box by more completely occupying the glove box.

A flexible membrane 44 is mounted to the bottom panel 32 and substantially occupies the recess 42, thereby sealing the bottom panel 32 of the glove box organizer 30. By filling the recess 42, the flexible membrane 44 prevents wear and tear upon items placed in the glove box organizer 30 adjacent to the bottom panel 32, while enabling the recess 42 to receive the locking mechanism of the glove box.

The outer surface of the bottom panel 32 of the glove box organizer 30 is, at least partially, made from or coated by a material that is configured to engage the surface of the bottom wall of the glove box and prevent the glove box organizer 30 from shifting during use. For instance, the outer surface of the bottom panel 32 can be made from or covered by hook fasteners, plastic or rubber fingers or pins that engage a felt or cloth interior of the glove box. Alternatively, the outer surface of the bottom panel 32 can include strong adhesive, weak adhesive or tacky layers that engage a hard or smooth interior of the glove box. Alternatively, the bottom panel 32 can include a combination of both hook fasteners, plastic or rubber fingers or pins and strong adhesive, weak adhesive or tacky layers, such as alternating patches of each of the two types.

The accordion file folder 31 has folder-dividers 47 that are connected at each end to the side panels 38, 38. The folder-dividers 47 define folder sections of various sizes, such as “medium-sized” folder sections 48 and/or “large-sized” folder section 50. The medium-sized folder sections 48 are configured to store medium- and small-sized contents, such as documents, maps and media. Some of the medium-sized folder sections 48 include sub-dividers 52, for instance, which are positioned to separately store books, media disc cases (CD, DVD, Blu-Ray®, etc.) or the like within compartments defined by the sub-dividers 52.

The large-sized folder section 50 is configured to store large-sized and unusually-shaped contents, such as a user's manual of a vehicle, a book, a flashlight, a pair of gloves and the like. The large-sized folder section 50 also includes accessory compartments, such as pockets 54 and fitted holders 56. The pockets 54 are configured for receiving small-sized content items and, in particular, electronic devices, such as an mp3 player, a camera, a global positioning system (GPS) device or a mobile phone, and the wiring or cables for said electronic devices. The pockets 54 are elastically deformable and are capable of adjusting to securely store a range of content items in the glove box organizer 30. In contrast, the holders 56 are, generally, smaller and specifically configured or fitted to hold particular content items, such as business cards, pens and pencils, a pocket flashlight, a USB memory key, a pack of gum, sunglasses, driving glasses, a tube of lip moisturizer, containers of makeup and the like.

It should be appreciated that the folder-dividers 47 can be variably positioned to change the size of the respective folder sections, creating folder sections of any size (i.e., including small-sized folder sections).

It should be appreciated that the accessory compartments mounted to the folder sections, including the pocket, the fitted holder, the divider and the tab, can be positioned in any of the folder sections regardless of size or positioning within the glove box organizer, as desired.

The front opening 40 of the glove box organizer 30 defines a series of slots 46 through which contents are inserted into and removed from the folder sections 38 of the glove box organizer 30.

Tabs 58 extend from the folder-dividers 47 along the front opening 40 of the glove box organizer 30. Preferably, the tabs 58 are offset from one another in a staggered arrangement. The tabs 58 are configured to display labels outside of the folder sections 48, 50 of the glove box organizer 30. For example, the labels can display a range of descriptors, such as “EMERGENCY”, “MEDICAL”, “PERSONAL INFORMATION”, “VEHICLE”, “CAR INSURANCE”, “BANK”, “RECEIPTS” and the like. The descriptors can be words or graphical symbols, black and white or color coordinated, and smooth or textured to be more readily distinguishable. For exemplary purposes, the “EMERGENCY” label can be used to designate a folder section as a repository for critical information in the event of an emergency. This critical information might include a combination of: driver and frequent passenger medical information, such as allergies, current medications and blood type; vehicle registration and insurance information; personal information, such as a home address and telephone number, a name and number of the driver's next of kin or emergency contact; and the like.

The folder sections 48, 50 are expandable up to a maximum width. The overall width of the glove box organizer 30 is adjustably fixed using a rigid support 60. The rigid support 60 props open the glove box organizer 30 to facilitate access to the contents inserted in the glove box organizer 30. The rigid support 60 also clamps shut the glove box organizer 30. For instance, when the user removes the glove box organizer 30 from a glove box of a vehicle, it may be beneficial to clamp the glove box organizer 30 to prevent contents stored therein from falling out of the glove box organizer 30, even if the glove box organizer 30 is tipped or positioned such that the slots 46 of the front opening 40 of the glove box organizer 30 face generally downward.

The rigid support 60 is made from or reinforced by a rigid material, such as a textile (i.e., reinforced paper or corrugated cardboard), leather, plastic or metal. The rigid support 60 includes a coupling mechanism that interlocks opposing elements of the rigid support 60.

As shown in FIG. 3, the rigid support 60 is a pair of reinforcement strips 62 that are mounted to the glove box organizer 30 at the juncture of the bottom panel 32 and the side 38 and the top panel 36 and the side 38, such that the reinforcement strips 62 are positioned to abut each of the side panels 38, 38. Each of the reinforcement strips 62 includes a plastic tongue that is coated, at least on one side of the tongue, by a corresponding layer of hook and loop fastener material (i.e., Velcro®). By aligning and pressing together the reinforcement strips 62, the reinforcement strips 62 establish a fixed distance between the bottom panel 32 and the top panel 36 of the glove box organizer 30.

Referring to FIG. 4, the glove box organizer 30 is shown with contents stored therein. The contents are sorted and stored in the medium-sized folder sections 48, the larger-sized folder section 50, the pockets 54 and the fitted holders 56 of the glove box organizer 30, as desired. For instance, papers and assorted documentation are stored in the medium-sized folders, an owner's manual is stored in the large-sized folder section, a GPS device is inserted in the pocket and an identification card is stored in the fitted holder.

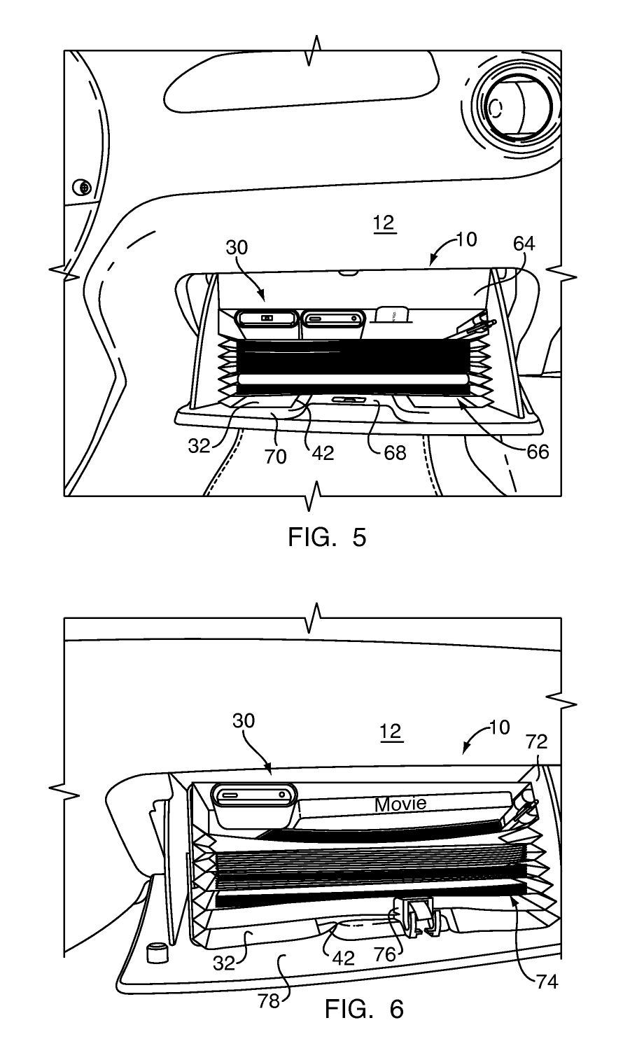

Referring to FIG. 5, the glove box organizer 30 is shown installed in a first glove box 64 with contents 66 stored therein. The glove box 64 has a locking mechanism 68 formed along a bottom wall 70 thereof.

Referring to FIG. 6, the glove box organizer 30 is shown installed in a second glove box 72 with different contents 74 stored therein. The glove box 72 shown in FIG. 6 includes a larger, more pronounced locking mechanism 76 formed on a bottom panel 78 thereof relative to the locking mechanism 68 of the glove box 64 shown in FIG. 5. As shown, the recess 42 in the bottom panel 32 of the glove box organizer 30 is capable of receiving the larger locking mechanism 76 when the glove box organizer 30 is positioned in the glove box 72.

As shown in FIGS. 5-6, the contents 66, 74 are sorted, organized and securely retained in the respective glove box 64, 72 using the glove box organizer 30.

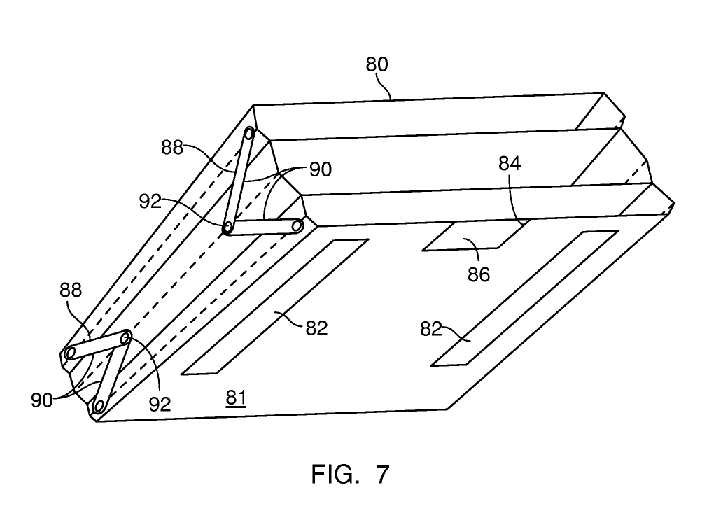

Referring to FIG. 7, a glove box organizer 80 according to a different embodiment is shown. As shown in FIG. 7, the glove box organizer 80 includes an accordion file folder having two folder dividers that define three folder sections. A bottom panel 81 of the glove box organizer 80 is made from or coated by a material that engages the bottom wall of the glove box, thereby securing (i.e., laterally) the glove box organizer 80 in the glove box. For instance, the bottom panel 81 is covered by two patches 82, 82 of the engaging material.

The bottom panel 81 defines a recess 84 and has a flexible membrane 86 mounted therein, as discussed above.

The glove box organizer 80 has a rigid support disposed along each side. The rigid support of the glove box organizer 80 includes two pairs of jaws 88, 88 (only one pair of which is shown on the facing-side of the glove box organizer 78 in FIG. 7). Each of the jaws 88, 88 is formed from two interlocking reinforcement strips 90, 90, 90, 90 having ends connected to a respective corner of a side of the glove box organizer 80, and a joint 92, 92 disposed therebetween. The joint 92, 92 has a relatively high friction characteristic, which retains the positioning of the reinforcement strips 90, 90, 90, 90 relative to one another. By adjusting the position of the joint 92, 92, for instance, toward or away from the rear panel of the glove box organizer 80, the displacement of the top panel and the bottom panel of the glove box organizer 80 is controlled.

Since there are two jaws 88, 88 on each side of the glove box organizer 80, the overall geometry (i.e., the fixed shape) of the glove box organizer 80 can be changed from substantially box shaped to substantially wedge shaped in order to conform to various glove boxes, to securely retain contents within the glove box organizer 80 and to facilitate insertion of contents into the glove box organizer 80.

It should be understood that the foregoing description is only illustrative of the invention. Various alternatives and modifications can be devised by those skilled in the art without departing from the broader aspects of the present invention.

According to an alternative embodiment, the rigid support is a pair of reinforcement strips that are made from a rigid material, such as plastic, and the coupling mechanism is formed by an affixing configuration of the reinforcement strips, such as a matching set of interlocking ridges.

What is claimed is:

1. A glove box organizer comprising:
an accordion file folder having a bottom panel, a rear panel abutting the bottom panel, a top panel abutting the rear panel and side panels abutting the bottom panel, the rear panel and the top panel;
a folder-divider positioned between the bottom panel and the top panel, the folder-divider defining, at least in part, two folder sections; and
a rigid support mounted to the file folder, positioned to abut the side panels and configured to adjustably retain the bottom panel and the top panel at a fixed distance from one another thereby controlling the size of the folder sections.

2. The glove box organizer according to claim 1, wherein:
the rigid support further comprises:
two pairs of reinforcement strips;
one of the pairs of reinforcement strips is positioned to abut one side panel of the file folder system;
another of the pairs of reinforcement strips is positioned to abut another side panel of the file folder system;
the reinforcement strips are made from or reinforced by a rigid material; and
the reinforcement strips include a coupling mechanism.

3. The glove box organizer according to claim 2, wherein:
the rigid material is selected from the group consisting of: a textile, a leather, a plastic and a metal; and
the coupling mechanism includes corresponding hook and loop fasteners mounted to respective ones of each pair of reinforcement strips.

4. The glove box organizer according to claim 1, wherein:
two of the folder sections are differently sized.

5. The glove box organizer according to claim 1, further comprising:
an elastically deformable pocket mounted to the file folder in one of the folder sections.

6. The glove box organizer according to claim 1, further comprising:
a holder mounted to the file folder in one of the folder sections.

7. The glove box organizer according to claim 1, further comprising:
a sub-divider mounted to one of the folder-dividers and another one of the folder-dividers, the top panel or the bottom panel.

8. The glove box organizer according to claim 1, wherein:
edges of the bottom panel, the top panel and the side panels define a front opening that is remote from the rear panel; and
the glove box organizer further comprising:
a tab extending from the folder-divider, positioned to abut or extend past the front opening and configured to display a label outside of the folder sections.

9. The glove box organizer according to claim 1, wherein:
the outer surface of the bottom panel is, at least partially, made from or coated by a material selected from the group consisting of: hook fasteners, plastic or rubber fingers, plastic or rubber pins, and an adhesive.

10. The glove box organizer according to claim 1, wherein:
edges of the bottom panel, the top panel and the side panels define a front opening that is remote from the rear panel;
the edge of the bottom panel that abuts the front opening defines a recess, the recess being configured to receive a locking mechanism of a glove box of a motor vehicle; and
the glove box organizer further comprising:
a flexible membrane mounted to the bottom panel and positioned to substantially occupy the recess, the flexible membrane sealing the bottom panel of the file folder while enabling the recess to engage a locking mechanism of a glove box of a motor vehicle.

11. A glove box organizer comprising:
an accordion file folder having a bottom panel, a rear panel abutting the bottom panel, a top panel abutting the rear panel and side panels abutting the bottom panel, the rear panel and the top panel, wherein:
edges of the bottom panel, the top panel and the side panels define a front opening that is remote from the rear panel;
the bottom panel defines a recess along the edge of the bottom panel that abuts the front opening; and
the recess is configured to receive a locking mechanism of a glove box of a motor vehicle;
a folder-divider positioned between the bottom panel and the top panel, wherein:
the folder-divider defines, at least in part, two folder sections;
each folder section defines a slot in the front opening; and
a flexible membrane mounted to the bottom panel and positioned to substantially occupy the recess.

12. The glove box organizer according to claim 11, wherein:
the flexible membrane seals the bottom panel of the file folder while enabling the recess to engage a locking mechanism of a glove box of a motor vehicle.

13. The glove box organizer according to claim 11, wherein:
two of the folder sections are differently sized.

14. The glove box organizer according to claim 11, further comprising:
an elastically deformable pocket mounted to the file folder in one of the folder sections.

15. The glove box organizer according to claim 11, further comprising:
a holder mounted to the file folder in one of the folder sections.

16. The glove box organizer according to claim 11, further comprising:
a sub-divider mounted to one of the folder-dividers and another one of the folder-dividers, the top panel or the bottom panel.

17. The glove box organizer according to claim 11, further comprising:
a tab extending from the folder-divider, positioned to abut or extend past the front opening and configured to display a label outside of the folder sections.

18. The glove box organizer according to claim 11, further comprising:
a rigid support mounted to the file folder, positioned to abut one of the side panels and configured to adjustably retain the bottom panel and the top panel at a fixed distance from one another thereby controlling the size of the folder sections.

19. The glove box organizer according to claim 11, wherein:
the rigid support further comprises:
two pairs of reinforcement strips positioned to abut the side panels;
one of the pairs of reinforcement strips is positioned to abut one of the side panels;
another of the pairs of reinforcement strips is positioned to abut another of the side panels;
the reinforcement strips are made from or reinforced by a rigid material;
the reinforcement strips include a coupling mechanism.

20. A glove box organizer for organizing contents of a glove box of a motor vehicle, the glove box organizer consisting of:
an accordion file folder having a bottom panel, a rear panel abutting the bottom panel, a top panel abutting the rear panel and side panels abutting the bottom panel, the rear panel and the top panel, wherein:
edges of the bottom panel, the top panel and the side panels define a front opening that is remote from the rear panel;
the edge of the bottom panel that abuts the front opening defines a recess; and
the recess is configured to receive a locking mechanism of a glove box of a motor vehicle;
at least one folder-divider positioned between the bottom panel and the top panel, the at least one folder-divider defining, at least in part, two folder sections, at least two of the at least two folder sections being differently sized;
at least one elastically deformable pocket mounted in one of the folder sections;
at least one holder mounted in one of the folder sections;
a rigid support mounted to the file folder, positioned to abut the side panels and configured to adjustably retain the bottom panel and the top panel at a fixed distance from one another thereby controlling the size of the at least two folder sections; and
at least one tab mounted to one of the folder-dividers, positioned to abut or extend past the front opening and configured to display a label.
